(19) United States
(12) Patent Application Publication
(10) Pub. No.: US 2006/0216831 A1
(43) Pub. Date: Sep. 28, 2006

(54) Methods for automated collection of small volume of liquid

(75) Inventors: Devin Nguyen, San Jose, CA (US); Mohsen Shirazi, San Jose, CA (US)

Correspondence Address: AFFYMETRIX, INC;ATTN: CHIEF IP COUNSEL, LEGAL DEPT., 3420 CENTRAL EXPRESSWAY, SANTA CLARA, CA, 95051, US

(73) Assignee: Affymetrix, INC., Santa Clara, CA (US)

(21) Appl. No.: 11/445,829

(22) Filed: Jun. 1, 2006

Related U.S. Application Data
(63) Continuation of application No. 10/318,691, filed on Dec. 12, 2002, now abandoned.

(51) Int. Cl. B01L 3/00

(52) U.S. Cl. 436/180

(57) ABSTRACT

In one embodiment of the invention, methods are provided for collecting the content of microtiter plate well An automated pipett is programmed to aspirate along the wall of a microtiter well at defined intervals to collect liquid that may be on the walls of the well

### INTRODUCTION

This application is related to laboratory automation More specifically, in some embodiments of the invention, methods are provided for automated handling of small volume of liquid

Automated handling of small volume of liquid is important for high throughput, automated laboratory processes In some biological assays, it is often important to collect the entire content of a reaction (such as the entire content of a well in a microtiter plate) Therefore, there is a need in the art for reliable, automated methods for collecting small volume of liquid from a reaction vessel such as the wells of a microtiter plate

### SUMMARY OF THE INVENTION

In automated, high throughput assay, it is often desirable to collect the entire content of a well in a microtiter plate For example, high throughput nucleic acid sample preparation process often include steps for eluting nucleic acids from a membrane (such as a membrane that is embedded in the bottom of microtiter plate well, e g, MiniElute 96 from Qiagen) It is important to collect the elutant that contains the nucleic acids of interest Similarly, automated purification of peptides may also involve collection of all the liquid from a reaction vessel

In one aspect of the invention, a method for collecting the liquid content of microtiter well is provided The method includes optionally shaking the microtiter well, moving a pipett tip along the wall of the well, and aspirating at a plurality of positions The aspirating step may include aspirating at least the expected volume at each of the plurality of positions In preferred embodiments, the step of moving includes lifting the pipett tip, translating to a desired position and lowering the tip for aspiration In some embodiments, aspiration occurs in at least four, five, six, seven or more positions In preferred embodiments, the moving and aspirating are performed by a programmable, automated device such as a laboratory automation workstation like the Biomek® FX

Once the contents is aspirated, the liquid content may be dispensed The methods of the invention are particularly suitable for handling a large number of biological samples Multichannel pipetts may be used to simultaneously handle eight or more pipett tips

In another aspect of the invention, computer software products are provided The software products contain codes that controls a laboratory automation device to perform the methods of the invention and the codes are stored in a computer readable medium such as a harddrive, a CD-Rom, a DVD-Rom, flash memory device, etc

In yet another aspect of the invention, a system for performing the methods of the invention is provided The system may include a computer that executing the computer software of the invention

### BRIEF DESCRIPTION OF THE FIGURES

The accompanying drawings, which are incorporated in and form a part of this specification, illustrate embodiments of the invention and, together with the description, serve to explain the embodiments of the invention

FIG. 1 is schematic showing a multichannel automated pipetting system for collecting liquid from wells of a microtiter plate

FIG. 2 is a schematic showing the collection of liquid drop from the well

FIG. 3 is a schematic showing the collection of liquid drop from a well of a microtier plate

### DETAILED DESCRIPTION OF THE EMBODIMENTS OF THE INVENTION

The present invention has many preferred embodiments and relies on many patents, applications and other references for details known to those of the art Therefore, when a patent, application, or other reference is cited or repeated below, it should be understood that it is incorporated by reference in its entirety for all purposes as well as for the proposition that is recited

I. General

As used in this application, the singular form “a,” “an,” and “the” include plural references unless the context clearly dictates otherwise For example, the term “an agent” includes a plurality of agents, including mixtures thereof

An individual is not limited to a human being but may also be other organisms including but not limited to mammals, plants, bacteria, or cells derived from any of the above

Throughout this disclosure, various aspects of this invention can be presented in a range format It should be understood that the description in range format is merely for convenience and brevity and should not be construed as an inflexible limitation on the scope of the invention Accordingly, the description of a range should be considered to have specifically disclosed all the possible subranges as well as individual numerical values within that range For example, description of a range such as from 1 to 6 should be considered to have specifically disclosed subranges such as from 1 to 3, from 1 to 4, from 1 to 5, from 2 to 4, from 2 to 6, from 3 to 6 etc, as well as individual numbers within that range, for example, 1, 2, 3, 4, 5, and 6 This applies regardless of the breadth of the range

The practice of the present invention may employ, unless otherwise indicated, conventional techniques and descriptions of organic chemistry, polymer technology, molecular biology (including recombinant techniques), cell biology, biochemistry, and immunology, which are within the skill of the art Such conventional techniques include polymer array synthesis, hybridization, ligation, and detection of hybridization using a label Specific illustrations of suitable techniques can be had by reference to the example herein below However, other equivalent conventional procedures can, of course, also be used Such conventional techniques and descriptions can be found in standard laboratory manuals such as Genome Analysis A Laboratory Manual Series (Vols I-IV), Using Antibodies A Laboratory Manual, Cells A Laboratory Manual, PCR Primer A Laboratory Manual, and Molecular Cloning A Laboratory Manual (all from Cold Spring Harbor Laboratory Press), Stryer, L (1995) Biochemistry (4th Ed) Freeman, N.Y., Gait, “Oligonucleotide Synthesis A Practical Approach” 1984, IRL Press, London, Nelson and Cox (2000), Lehninger, Principles of Biochemistry 3rd Ed, W H Freeman Pub, New York, N.Y. and Berg et al (2002) Biochemistry, 5th Ed, W H Freeman Pub, New York, N.Y., all of which are herein incorporated in their entirety by reference for all purposes

The present invention can employ solid substrates, including arrays in some preferred embodiments Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos PCT/US99/00730 (International Publication Number WO 99/36760) and PCT/US01/04285, which are all incorporated herein by reference in their entirety for all purposes

Patents that describe synthesis techniques in specific embodiments include U.S. Pat. Nos. 5,412,087, 6,147,205, 6,262,216, 6,310,189, 5,889,165, and 5,959,098 Nucleic acid arrays are described in many of the above patents, but the same techniques are applied to polypeptide arrays

Nucleic acid arrays that are useful in the present invention include those that are commercially available from Affymetrix (Santa Clara, Calif.) under the brand name GeneChip®Example arrays are shown on the website at affymetrix com The present invention also contemplates many uses for polymers attached to solid substrates These uses include gene expression monitoring, profiling, library screening, genotyping and diagnostics Gene expression monitoring, and profiling methods can be shown in U.S. Pat. Nos. 5,800,992, 6,013,449, 6,020,135, 6,033,860, 6,040,138, 6,177,248 and 6,309,822 Genotyping and uses therefore are shown in U.S. Ser. No. 60/319,253, 10/013,598, and U.S. Pat. Nos. 5,856,092, 6,300,063, 5,858,659, 6,284,460, 6,361,947, 6,368,799 and 6,333,179 Other uses are embodied in U.S. Pat. Nos. 5,871,928, 5,902,723, 6,045,996, 5,541,061, and 6,197,506

The present invention also contemplates sample preparation methods in certain preferred embodiments Prior to or concurrent with genotyping, the genomic sample may be amplified by a variety of mechanisms, some of which may employ PCR See, e g, PCR Technology Principles and Applications for DNA Amplification (Ed H A Erlich, Freeman Press, NY, N.Y., 1992), PCR Protocols A Guide to Methods and Applications (Eds Innis, et al, Academic Press, San Diego, Calif., 1990), Mattila et al, Nucleic Acids Res 19, 4967 (1991), Eckert et al, PCR Methods and Applications 1, 17 (1991), PCR (Eds McPherson et al, IRL Press, Oxford), and U.S. Pat. Nos. 4,683,202, 4,683,195, 4,800,159 4,965,188, and 5,333,675, and each of which is incorporated herein by reference in their entireties for all purposes The sample may be amplified on the array See, for example, U.S. Pat. No. 6,300,070 and U.S. patent application Ser. No. 09/513,300, which are incorporated herein by reference

Other suitable amplification methods include the ligase chain reaction (LCR) (e g, Wu and Wallace, Genomics 4, 560 (1989), Landegren et al, Science 241, 1077 (1988) and Barringer et al Gene 89 117 (1990)), transcription amplification (Kwoh et al, Proc Natl Acad Sci USA 86,1173 (1989) and WO88/10315), self sustained sequence replication (Guatelli et al, Proc Nat Acad Sci USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909, 5,861,245) and nucleic acid based sequence amplification (NABSA) (See, U.S. Pat. Nos. 5,409,818, 5,554,517, and 6,063,603, each of which is incorporated herein by reference) Other amplification methods that may be used are described in, U.S. Pat. Nos. 5,242,794, 5,494,810, 4,988,617 and in U.S. Ser. No. 09/854,317, each of which is incorporated herein by reference

Additional methods of sample preparation and techniques for reducing the complexity of a nucleic sample are described in Dong et al, Genome Research 11, 1418 (2001), in U.S. Pat. Nos. 6,361,947, 6,391,592 and U.S. patent application Nos. 09/916,135, 09/920,491, 09/910,292, and 10/013,598

Methods for conducting polynucleotide hybridization assays have been well developed in the art Hybridization assay procedures and conditions will vary depending on the application and are selected in accordance with the general binding methods known including those referred to m Maniatis et al Molecular Cloning A Laboratory Manual (2nd Ed Cold Spring Harbor, N.Y., 1989), Berger and Kimmel Methods in Enzymology, Vol 152, Guide to Molecular Cloning Techniques (Academic Press, Inc, San Diego, Calif., 1987), Young and Davism, P N A S, 80 1194 (1983) Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference

The present invention also contemplates signal detection of hybridization between ligands in certain preferred embodiments See U.S. Pat. Nos. 5,143,854, 5,578,832, 5,631,734, 5,834,758, 5,936,324, 5,981,956, 6,025,601, 6,141,096, 6,185,030, 6,201,639, 6,218,803, and 6,225,625, in U.S. Patent application 60/364,731 and in PCT Application PCT/US99/06097 (published as WO99/47964), each of which also is hereby incorporated by reference in its entirety for all purposes

Methods and apparatus for signal detection and processing of intensity data are disclosed in, for example, U.S. Pat. Nos. 5,143,854, 5,547,839, 5,578,832, 5,631,734, 5,800,992, 5,834,758, 5,856,092, 5,902,723, 5,936,324, 5,981,956, 6,025,601, 6,090,555, 6,141,096, 6,185,030, 6,201,639, 6,218,803, and 6,225,625, in U.S. Patent application 60/364,731 and in PCT Application PCT/US99/06097 (published as WO99/47964), each of which also is hereby incorporated by reference in its entirety for all purposes

The practice of the present invention may also employ conventional biology methods, software and systems Computer software products of the invention typically include computer readable medium having computer-executable instructions for performing the logic steps of the method of the invention Suitable computer readable medium include floppy disk, CD-ROM/DVD/DVD-ROM, hard-disk drive, flash memory, ROM/RAM, magnetic tapes and etc The computer executable instructions may be written in a suitable computer language or combination of several languages Basic computational biology methods are described in, e g Setubal and Meidanis et al, Introduction to Computational Biology Methods (PWS Publishing Company, Boston, 1997), Salzberg, Searles, Kasif, (Ed), Computational Methods in Molecular Biology, (Elsevier, Amsterdam, 1998), Rashidi and Buehler, Bioinformatics Basics Application in Biological Science and Medicine (CRC Press, London, 2000) and Ouelette and Bzevanis Bioinformatics A Practical Guide for Analysis of Gene and Proteins (Wiley & Sons, Inc, 2nd ed, 2001)

The present invention may also make use of various computer program products and software for a variety of purposes, such as probe design, management of data, analysis, and instrument operation See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170

Additionally, the present invention may have preferred embodiments that include methods for providing genetic information over networks such as the Internet as shown in U.S. patent application Ser. Nos. 10/063,559, 60/349,546, 60/376,003, 60/394,574, 60/403,381

II Glossary

The following terms are intended to have the following general meanings as there used herein

Nucleic acids according to the present invention may include any polymer or oligomer of pyrimidine and purine bases, preferably cytosine (C), thymine (T), and uracil (U), and adenine (A) and guanine (G), respectively See Albert L Lehninger, PRINCIPLES OF BIOCHEMISTRY, at 793-800 (Worth Pub 1982) Indeed, the present invention contemplates any deoxyribonucleotide, ribonucleotide or peptide nucleic acid component, and any chemical variants thereof, such as methylated, hydroxymethylated or glucosylated forms of these bases, and the like The polymers or oligomers may be heterogeneous or homogeneous in composition, and may be isolated from naturally occurring sources or may be artificially or synthetically produced In addition, the nucleic acids may be deoxyribonucleic acid (DNA) or ribonucleic acid (RNA), or a mixture thereof, and may exist permanently or transitionally in single-stranded or double-stranded form, including homoduplex, heteroduplex, and hybrid states

An “oligonucleotide” or “polynucleotide” is a nucleic acid ranging from at least 2, preferable at least 8, and more preferably at least 20 nucleotides in length or a compound that specifically hybridizes to a polynucleotide Polynucleotides of the present invention include sequences of deoxyribonucleic acid (DNA) or ribonucleic acid (RNA), which may be isolated from natural sources, recombinantly produced or artificially synthesized and mimetics thereof A further example of a polynucleotide of the present invention may be peptide nucleic acid (PNA) in which the constituent bases are joined by peptides bonds rather than phosphodiester linkage, as described in Nielsen et al, Science 254 1497-1500 (1991), Nielsen Curr Opin Biotechnol, 10 71-75 (1999) The invention also encompasses situations in which there is a nontraditional base paring such as Hoogsteen base pairing which has been identified m certain tRNA molecules and postulated to exist in a triple helix “Polynucleotide” and “oligonucleotide” are used interchangeably in this application

An “array” is an intentionally created collection of molecules which can be prepared either synthetically or biosynthetically The molecules in the array can be identical or different from each other The array can assume a variety of formats, e g, libraries of soluble molecules, libraries of compounds tethered to resin beads, silica chips, or other solid supports

Nucleic acid library or array is an intentionally created collection of nucleic acids which can be prepared either synthetically or biosynthetically in a variety of different formats (e g, libraries of soluble molecules, and libraries of oligonucleotides tethered to resin beads, silica chips, or other solid supports) Additionally, the term “array” is meant to include those libraries of nucleic acids which can be prepared by spotting nucleic acids of essentially any length (e g, from 1 to about 1000 nucleotide monomers in length) onto a substrate The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases The backbone of the polynucleotide can comprise sugars and phosphate groups, as may typically be found in RNA or DNA, or modified or substituted sugar or phosphate groups A polynucleotide may comprise modified nucleotides, such as methylated nucleotides and nucleotide analogs The sequence of nucleotides may be interrupted by non-nucleotide components Thus the terms nucleoside, nucleotide, deoxynucleoside and deoxynucleotide generally include analogs such as those described herein These analogs are those molecules having some structural features in common with a naturally occurring nucleoside or nucleotide such that when incorporated into a nucleic acid or oligonucleotide sequence, they allow hybridization with a naturally occurring nucleic acid sequence in solution Typically, these analogs are derived from naturally occurring nucleosides and nucleotides by replacing and/or modifying the base, the ribose or the phosphodiester moiety The changes can be tailor made to stabilize or destabilize hybrid formation or enhance the specificity of hybridization with a complementary nucleic acid sequence as desired

“Solid support”, “support”, and “substrate” are used interchangeably and refer to a material or group of materials having a rigid or semi-rigid surface or surfaces In many embodiments, at least one surface of the solid support will be substantially flat, although in some embodiments it may be desirable to physically separate synthesis regions for different compounds with, for example, wells, raised regions, pins, etched trenches, or the like According to other embodiments, the solid support(s) will take the form of beads, resins, gels, microspheres, or other geometric configurations

Combinatorial Synthesis Strategy A combinatorial synthesis strategy is an ordered strategy for parallel synthesis of diverse polymer sequences by sequential addition of reagents which may be represented by a reactant matrix and a switch matrix, the product of which is a product matrix A reactant matrix is a 1 column by m row matrix of the building blocks to be added The switch matrix is all or a subset of the binary numbers, preferably ordered, between 1 and m arranged in columns A “binary strategy” is one in which at least two successive steps illuminate a portion, often half, of a region of interest on the substrate In a binary synthesis strategy, all possible compounds which can be formed from an ordered set of reactants are formed In most preferred embodiments, binary synthesis refers to a synthesis strategy which also factors a previous addition step For example, a strategy in which a switch matrix for a masking strategy halves regions that were previously illuminated, illuminating about half of the previously illuminated region and protecting the remaining half (while also protecting about half of previously protected regions and illuminating about half of previously protected regions) It will be recognized that binary rounds may be interspersed with non-binary rounds and that only a portion of a substrate may be subjected to a binary scheme A combinatorial “masking” strategy is a synthesis which uses light or other spatially selective deprotecting or activating agents to remove protecting groups from materials for addition of other materials such as amino acids

Monomer refers to any member of the set of molecules that can be joined together to form an oligomer or polymer The set of monomers useful in the present invention includes, but is not restricted to, for the example of (poly)peptide synthesis, the set of L-amino acids, D-amino acids, or synthetic amino acids As used herein, “monomer” refers to any member of a basis set for synthesis of an oligomer For example, dimers of L-amino acids form a basis set of 400 “monomers” for synthesis of polypeptides Different basis sets of monomers may be used at successive steps in the synthesis of a polymer The term “monomer” also refers to a chemical subunit that can be combined with a different chemical subunit to form a compound larger than either subunit alone

Biopolymer or biological polymer is intended to mean repeating units of biological or chemical moieties Representative biopolymers include, but are not limited to, nucleic acids, oligonucleotides, amino acids, proteins, peptides, hormones, oligosaccharides, lipids, glycolipids, lipopolysaccharides, phospholipids, synthetic analogues of the foregoing, including, but not limited to, inverted nucleotides, peptide nucleic acids, Meta-DNA, and combinations of the above “Biopolymer synthesis” is intended to encompass the synthetic production, both organic and inorganic, of a biopolymer

Related to a bioploymer is a “biomonomer” which is intended to mean a single unit of biopolymer, or a single unit which is not part of a biopolymer Thus, for example, a nucleotide is a biomonomer within an oligonucleotide biopolymer, and an amino acid is a biomonomer within a protein or peptide biopolymer, avidin, biotin, antibodies, antibody fragments, etc, for example, are also biomonomers Initiation Biomonomer or “initator biomonomer” is meant to indicate the first biomonomer which is covalently attached via reactive nucleophiles to the surface of the polymer, or the first biomonomer which is attached to a linker or spacer arm attached to the polymer, the linker or spacer arm being attached to the polymer via reactive nucleophiles

Complementary or substantially complementary Refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified Complementary nucleotides are, generally, A and T (or A and U), or C and G Two single stranded RNA or DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100% Alternatively, substantial complementarity exists when an RNA or DNA strand will hybridize under selective hybridization conditions to its complement Typically, selective hybridization will occur when there is at least about 65% complementary over a stretch of at least 14 to 25 nucleotides, preferably at least about 75%, more preferably at least about 90% complementary See, M Kanehisa Nucleic Acids Res 12 203 (1984), incorporated herein by reference

The term “hybridization” refers to the process in which two single-stranded polynucleotides bind non-covalently to form a stable double-stranded polynucleotide The term “hybridization” may also refer to triple-stranded hybridization The resulting (usually) double-stranded polynucleotide is a “hybrid ”The proportion of the population of polynucleotides that forms stable hybrids is referred to herein as the “degree of hybridization”

Hybridization conditions will typically include salt concentrations of less than about 1 M, more usually less than about 500 mM and less than about 200 mM Hybridization temperatures can be as low as 5° C., but are typically greater than 22° C., more typically greater than about 30° C., and preferably in excess of about 37° C. Hybridizations are usually performed under stringent conditions, i e conditions under which a probe will hybridize to its target subsequence Stringent conditions are sequence-dependent and are different in different circumstances Longer fragments may require higher hybridization temperatures for specific hybridization As other factors may affect the stringency of hybridization, including base composition and length of the complementary strands, presence of organic solvents and extent of base mismatching, the combination of parameters is more important than the absolute measure of any one alone Generally, stringent conditions are selected to be about 5° C. lower than the thermal melting point™ fro the specific sequence at s defined ionic strength and pH The Tm is the temperature (under defined ionic strength, pH and nucleic acid composition) at which 50% of the probes complementary to the target sequence hybridize to the target sequence at equilibrium

Typically, stringent conditions include salt concentration of at least 0 01 M to no more than 1 M Na ion concentration (or other salts) at a pH 7 0 to 8 3 and a temperature of at least 25° C. For example, conditions of 5× SSPE (750 mM NaCl, 50 mM NaPhosphate, 5 mM EDTA, pH 7 4) and a temperature of 25-30° C. are suitable for allele-specific probe hybridizations For stringent conditions, see for example, Sambrook, Fritsche and Maniatis “Molecular Cloning A laboratory Manual” 2nd Ed Cold Spring Harbor Press (1989) and Anderson “Nucleic Acid Hybridization” 1st Ed, BIOS Scientific Publishers Limited (1999), which are hereby incorporated by reference in its entirety for all purposes above

Hybridization probes are nucleic acids (such as oligonucleotides) capable of binding in a base-specific manner to a complementary strand of nucleic acid Such probes include peptide nucleic acids, as described in Nielsen et al, Science 254 1497-1500 (1991), Nielsen Curr Opin Biotechnol, 10 71-75 (1999) and other nucleic acid analogs and nucleic acid mimetics See U.S. Pat. No. 6,156,501 filed Apr. 3, 1996

Hybridizing specifically to refers to the binding, duplexing, or hybridizing of a molecule substantially to or only to a particular nucleotide sequence or sequences under stringent conditions when that sequence is present in a complex mixture (e g, total cellular) DNA or RNA

Probe A probe is a molecule that can be recognized by a particular target In some embodiments, a probe can be surface immobilized Examples of probes that can be investigated by this invention include, but are not restricted to, agonists and antagonists for cell membrane receptors, toxins and venoms, viral epitopes, hormones (e g, opioid peptides, steroids, etc), hormone receptors, peptides, enzymes, enzyme substrates, cofactors, drugs, lectins, sugars, oligonucleotides, nucleic acids, oligosaccharides, proteins, and monoclonal antibodies

Target A molecule that has an affinity for a given probe Targets may be naturally-occurring or man-made molecules Also, they can be employed in their unaltered state or as aggregates with other species Targets may be attached, covalently or noncovalently, to a binding member, either directly or via a specific binding substance Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles Targets are sometimes referred to in the art as anti-probes As the term targets is used herein, no difference in meaning is intended A “Probe Target Pair” is formed when two macromolecules have combined through molecular recognition to form a complex

Effective amount refers to an amount sufficient to induce a desired result

mRNA or mRNA transcripts as used herein, include, but not limited to pre-mRNA transcript(s), transcript processing intermediates, mature mRNA(s) ready for translation and transcripts of the gene or genes, or nucleic acids derived from the mRNA transcript(s) Transcript processing may include splicing, editing and degradation As used herein, a nucleic acid derived from an mRNA transcript refers to a nucleic acid for whose synthesis the mRNA transcript or a subsequence thereof has ultimately served as a template Thus, a cDNA reverse transcribed from an mRNA, a cRNA transcribed from that cDNA, a DNA amplified from the cDNA, an RNA transcribed from the amplified DNA, etc, are all derived from the mRNA transcript and detection of such derived products is indicative of the presence and/or abundance of the original transcript in a sample Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like

A fragment, segment, or DNA segment refers to a portion of a larger DNA polynucleotide or DNA A polynucleotide, for example, can be broken up, or fragmented into, a plurality of segments Various methods of fragmenting nucleic acid are well known in the art These methods may be, for example, either chemical or physical in nature Chemical fragmentation may include partial degradation with a DNase, partial depurination with acid, the use of restriction enzymes, intron-encoded endonucleases, DNA-based cleavage methods, such as triplex and hybrid formation methods, that rely on the specific hybridization of a nucleic acid segment to localize a cleavage agent to a specific location in the nucleic acid molecule, or other enzymes or compounds which cleave DNA at known or unknown locations Physical fragmentation methods may involve subjecting the DNA to a high shear rate High shear rates may be produced, for example, by moving DNA through a chamber or channel with pits or spikes, or forcing the DNA sample through a restricted size flow passage, e g, an aperture having a cross sectional dimension in the micron or submicron scale Other physical methods include sonication and nebulization Combinations of physical and chemical fragmentation methods may likewise be employed such as fragmentation by heat and ion-mediated hydrolysis See for example, Sambrook et al, “Molecular Cloning A Laboratory Manual,” 3rd Ed Cold Spring Harbor Laboratory Press, Cold Spring Harbor, N.Y. (2001) (“Sambrook et al) which is incorporated herein by reference for all purposes These methods can be optimized to digest a nucleic acid into fragments of a selected size range Useful size ranges may be from 100, 200, 400, 700 or 1000 to 500, 800, 1500, 2000, 4000 or 10,000 base pairs However, larger size ranges such as 4000, 10,000 or 20,000 to 10,000, 20,000 or 500,000 base pairs may also be useful

Polymorphism refers to the occurrence of two or more genetically determined alternative sequences or alleles in a population A polymorphic marker or site is the locus at which divergence occurs Preferred markers have at least two alleles, each occurring at frequency of greater than 1%, and more preferably greater than 10% or 20% of a selected population A polymorphism may comprise one or more base changes, an insertion, a repeat, or a deletion A polymorphic locus may be as small as one base pair Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu The first identified allelic form is arbitrarily designated as the reference form and other allelic forms are designated as alternative or variant alleles The allelic form occurring most frequently in a selected population is sometimes referred to as the wildtype form Diploid organisms may be homozygous or heterozygous for allelic forms A diallelic polymorphism has two forms A triallelic polymorphism has three forms Single nucleotide polymorphisms (SNPs) are included in polymorphisms

Single nucleotide polymorphism (SNPs) are positions at which two alternative bases occur at appreciable frequency (>1%) in the human population, and are the most common type of human genetic variation The site is usually preceded by and followed by highly conserved sequences of the allele (e g, sequences that vary in less than 1/100 or 1/1000 members of the populations) A single nucleotide polymorphism usually arises due to substitution of one nucleotide for another at the polymorphic site A transition is the replacement of one purine by another purine or one pyrimidine by another pyrimidine A transversion is the replacement of a purine by a pyrimidine or vice versa Single nucleotide polymorphisms can also arise from a deletion of a nucleotide or an insertion of a nucleotide relative to a reference allele

Genotyping refers to the determination of the genetic information an individual carries at one or more positions in the genome For example, genotyping may comprise the determination of which allele or alleles an individual carries for a single SNP or the determination of which allele or alleles an individual carries for a plurality of SNPs A genotype may be the identity of the alleles present in an individual at one or more polymorphic sites

III. Handling Small Volume of Liquid

In automated, high throughput assays, it is often desirable to collect the entire content of a well in a microtiter plate For example, high throughput nucleic acid sample preparation processes often include steps for eluting nucleic acids from a membrane (such as a membrane that is embedded in the bottom of microtiter plate well, e g, MiniElute 96 from Qiagen) It is important to collect the elutant that contains the nucleic acids of interest Similarly, automated purification of peptides may also involve collection of all the liquid from a reaction vessel

Many commercial robotic systems are now available for automated liquid handling (for example, Biomek FX from Beckman Instruments, Inc) Unfortunately, the liquid handling protocols typically leaves a residual volume (about 2 μl) of liquid If the total content is also small (such as 2-50 μl), the residual volume becomes a significant part of the total volume

In one aspect of the invention, methods, systems and computer software are provided for the automatic collection of liquids from microtiter plate wells (or other similar vessels) with very small amount or no residual volumes The methods, systems and computer software products are particularly useful for high throughput microtiter plate based gene expression monitoring, genotyping and resequencing assays They are also very useful for high throughput protein and nucleic acid preparation/isolation/purification

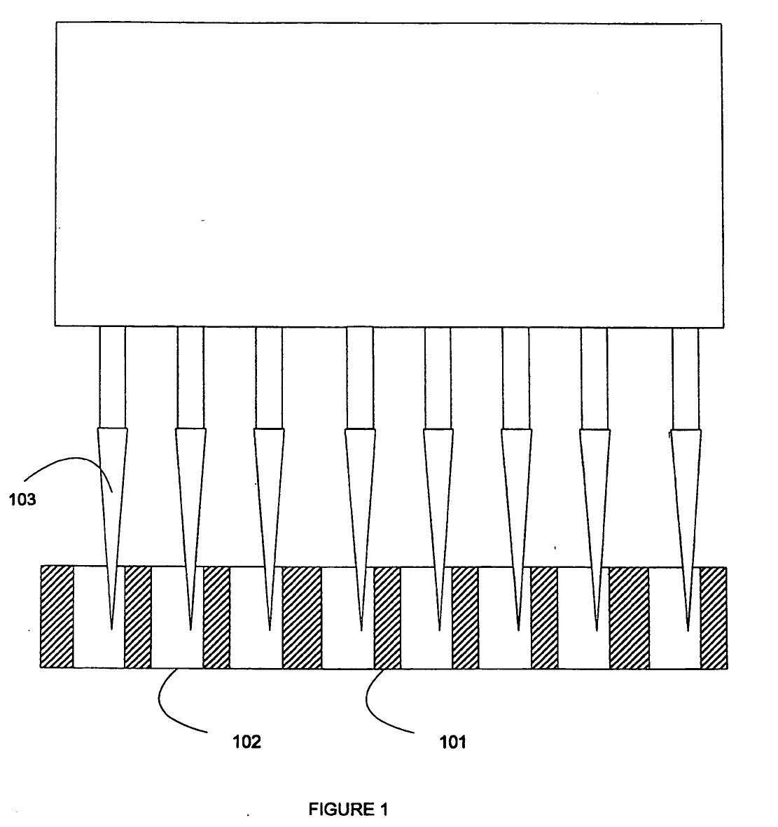

FIG. 1 shows an eight channel pipett with eight tips (103) in eight wells (102) of a microtiter plate (101) Automated multichannel pipetting capability is typically available in liquid handling devices such as the Biomek® FX laboratory automation system Such devices are typically controlled by a connected computer or an embedded system For Biomek® FX, a computer station that is connected with the laboratory automation workstation Biomek FX Software is used to program and control the laboratory automation workstation

Other laboratory automation workstations (automated liquid handling devices, laboratory robotic systems) have similar functions and are typically provided with programming functionalities

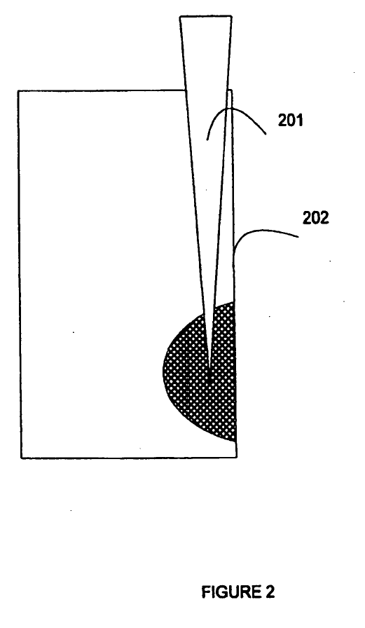

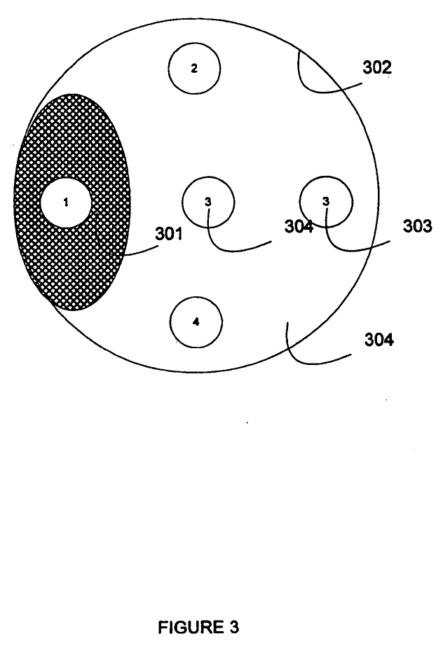

In some embodiments of the invention, a pipett tip is then moved to different positions to aspirate liquid content For example, the tip may be moved along the wall of the well and aspirate at defined intervals FIG. 2 shows a pipett is aspirating a small volume of liquid on the side of a microtiter well FIG. 3 shows the movement of the pipett tip In this example, the pipett tip was programmed to aspirate four times at positions 1, 2, 3 and 4 (or 0, 90, 180, 270 degree) and optionally in the center (the fifth position) The aspiration may be programmed to be for the entire expected volume, e g, if the entire volume is expected to be 50 uL, each aspiration (at each position) may be 50 uL (or slightly more) As shown in FIG. 3, the entire content of the well is at position 1 As a result, no liquid was picked up at position 2, 3, and 4 Because it is difficult to detect where the liquid is, aspiration at several different positions is important to ensure that the content is collected in one of the aspiration steps

The collected liquid may be dispensed to a different vessel such as a different microtiter well

In one aspect of the invention, a method for collecting the liquid content of microtiter well are provided The method includes shaking the microtiter well to make the liquid content to adhere to the wall of the well, moving a pipett tip along the wall of the well, and aspirating at a plurality of positions The aspirating step may include aspirating at least the expected volume at each of the plurality of positions In some embodiments, aspiration occurs in at least four positions In preferred embodiments, the moving and aspirating are performed by a programmable, automated device such as a laboratory automation workstation like the Biomek® FX

Once the content is aspirated, the liquid content may be dispensed The methods of the invention are particularly suitable for handling a large number of biological samples Multichannel pipetts may be used to simultaneously handle eight or more pipett tips

In another aspect of the invention, computer software products are provided The software products contain codes that controls a laboratory automation device to perform the methods of the invention and the codes are stored in a computer readable medium such as a harddrive, a CD-Rom, a DVD-Rom, flash memory device, etc

In yet another aspect of the invention, a system for performing the methods of the invention is provided The system may include a computer that executing the computer software of the invention

It is to be understood that the above description is intended to be illustrative and not restrictive Many variations of the invention will be apparent to those of skill in the art upon reviewing the above description The scope of the invention should be determined with reference to the appended claims, along with the full scope of equivalents to which such claims are entitled All cited references, including patent and non-patent literature, are incorporated herewith by reference in their entireties for all purposes

What is claimed is:

1) A method for collecting the liquid content of microtiter well comprising
Moving a pipett tip to a first position in the well,
Aspirating at the first position in the well,
Moving the pipett tip to a second position in the well, and
Aspirating at the second position in the well

2) The method of claim 1 wherein the method further comprises moving the pipett tip to a third position in the well and aspirating at the third position

3) The method of claim 2 wherein the aspirating comprising aspirating at least the expected volume at first, second and third positions

4) The method of claim 3 wherein the method further comprises moving the pipett tip to a fourth position and aspirating at the fourth position

5) The method of claim 4 wherein the first, second, third and fourth positions are along the well at 0, 90, 180, 270 degrees

6) The method of claim 5 wherein the method further comprises moving the pipett tip to a position that is approximately the center of the well

7) The method of claim 6 wherein the moving comprise lifting the pipett tip, transporting the pipett tip to the positions, and lowering the pipett tip

8) The method of claim 7 wherein the moving and aspirating are performed by a programmable, automated device

9) The method of claim 8 wherein the programmable, automated device is a laboratory automation workstation

10) The method of claim 9 wherein the laboratory automation workstation is Biomek® FX

11) The method of claim 10 further comprising dispensing the content of the pipett tip

12) The method of claim 1 wherein the steps are performed simultaneously in at least two wells

13) The method of claim 12 wherein the steps are performed simultaneously in at least eight wells

14) The method of claim 13 wherein the liquid content is a nucleic acid solution
